(19) United States
(12) Patent Application Publication
(10) Pub. No.: US 2023/0237279 A1
(43) Pub. Date: Jul. 27, 2023

(54) SYSTEM AND METHOD FOR BUILDING CONCEPT DATA STRUCTURES USING TEXT AND IMAGE INFORMATION

(71) Applicant: CONQ, Inc, Jacksonville, FL (US)

(72) Inventors: Mark S. O'Hare, Coto De Caza, CA (US); Richard L. Orsini, Flower Mound, TX (US); Roger Davenport, Metairie, LA (US)

(73) Assignee: CONQ, Inc, Jacksonville, FL (US)

(21) Appl. No.: 18/100,343

(22) Filed: Jan. 23, 2023

Related U.S. Application Data
(60) Provisional application No. 63/302,765, filed on Jan. 25, 2022.

(51) Int. Cl. G06F 40/40; G06F 40/211; G06V 30/262

(52) U.S. Cl. CPC G06F 40/40; G06F 40/211; G06V 30/262

(57) ABSTRACT

Systems, methods, and non-transitory computer-readable storage media for generating concept data structures, and more specifically to forming a concept data structure which relies on a combination of text and visual data. A system can receive, from a user, a concept, along with instructions to generate a concept data structure around the concept. The system can then receive from a data set documents containing data associated with the concept. These documents are parsed, resulting in structured text. The system can also receive (from the same or another data set) images associated with the concept. These images are analyzed, resulting in image data. The system then generates a concept data structure using the parsed, structured text and the image data.

### PRIORITY

This application claims priority to U.S. Provisional Pat. Application no. 63/302,765, filed Jan. 25, 2022, the contents of which are incorporated herein in their entirety.

### BACKGROUND

### 1. Technical Field

The present disclosure relates to concept data structures, and more specifically to forming a concept data structure which relies on a combination of text and visual data.

### 2. Introduction

Conventional methods for accessing data sets have focused on tactical searches, where the user seeks to match keywords, an approach that has several shortcomings. For example, a word may have multiple meanings—such as a Volkswagen bug, a software bug, and a garden bug. A better way of accessing data sets is through the use of concept data structures, where in order to provide a fuller picture of the theme or concept synonyms, aliases, or other related/inferred data may be compiled together. However, previous concept data structures fail to account for images which may belong or be associated with the concept.

### SUMMARY

Additional features and advantages of the disclosure will be set forth in the description that follows, and in part will be understood from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media which provide a technical solution to the technical problem described. A method for performing the concepts disclosed herein can include: receiving, from a user at a computer system, a concept; receiving, from the user at the computer system, instructions to generate a concept data structure around the concept; receiving, at the computer system from at least one data set, a plurality of documents containing data associated with the concept; parsing, via at least one processor of the computer system, the plurality of documents, resulting in parsed, structured text; receiving, at the computer system from at least one data set, a plurality of images associated with the concept; performing, via the at least one processor, at least one image analysis on the plurality of images, resulting in image data; and generating, via the at least one processor, a concept data structure using the parsed, structured text and the image data.

A system configured to perform the concepts disclosed herein can include: at least one processor; and a non-transitory computer-readable storage medium having instructions stored which, when executed by the at least one processor, cause the at least one processor to perform instructions comprising: receiving, from a user, a concept; receiving, from the user, instructions to generate a concept data structure around the concept; receiving, from at least one data set, a plurality of documents containing data associated with the concept; parsing the plurality of documents, resulting in parsed, structured text; receiving, from at least one data set, a plurality of images associated with the concept; performing at least one image analysis on the plurality of images, resulting in image data; and generating a concept data structure using the parsed, structured text and the image data.

A non-transitory computer-readable storage medium configured as disclosed herein can have instructions stored which, when executed by a computing device, cause the computing device to perform operations which include: receiving, from a user, a concept; receiving, from the user, instructions to generate a concept data structure around the concept; receiving, from at least one data set, a plurality of documents containing data associated with the concept; parsing the plurality of documents, resulting in parsed, structured text; receiving, from at least one data set, a plurality of images associated with the concept; performing at least one image analysis on the plurality of images, resulting in image data; and generating a concept data structure using the parsed, structured text and the image data.

### BRIEF DESCRIPTION OF THE DRAWINGS

FIG. 1 illustrates an example process flow for combining text and image information into a concept data structure;

FIG. 2 illustrates an example of combining text and image information for a specific topic;

FIG. 3 illustrates an example method embodiment; and

FIG. 4 illustrates an example computer system.

### DETAILED DESCRIPTION

Various embodiments of the disclosure are described in detail below. While specific implementations are described, it should be understood that this is done for illustration purposes only. Other components and configurations may be used without parting from the spirit and scope of the disclosure.

Systems configured as disclosed herein can process both text and images, identify relationships between data parsed via that processing, and define a concept data structure based on those relationships which incorporates both text and images. Consider the following example. A law enforcement user of the system is building a file associated with a gang called the “Molasses Gang.” The system has access to data sets storing criminal reports, accidents, criminal profiles, etc., and performs natural language processing on those stored documents, allowing the system to identify proper nouns, verbs, etc., from within the data of the various reports. In some configurations and circumstances, the system performs optical character recognition on the documents to obtain the data. With the data now parsed into its parts and syntactic roles, the system can run iterative and/or periodic searches for any known terms associated with the Molasses gang. When people, crimes, addresses, or other information associated with the gang’s activities are identified, they can be added to data structures which records information about the gang. If, for example, a criminal report identifies a person as a member of the Molasses gang, the system can then add information from that report to the gang’s data structure. In this manner, over time the data structure (referred to as a concept data structure) associated with the gang can be built over time. The data structure can also identify relationships between the data. If, for example, a person associated with the gang is involved in a crime, the data structure can identify a relationship between that user and that particular type of crime, whereas other gang associates not associated with that particular type of crime may not have any relationship with that particular type of crime. Additionally, these properties of a concept may also be used to reject information that is irrelevant or non-useful. Utilizing a set of rules the user may add, modify, or remove the qualities, keywords, and related concepts which this system utilizes to perform concept data analysis.

The concept data structure can also include images. If, for example, the system detects an image associated with one of the criminal reports, that image can be saved as part of the data structure, with a relationship linking the image to the other aspects of the crime. Image or video can be described and/or detected to add more information to a concept data structure.

The system can also process images to determine if there is any additional, data within the images which should be associated with a concept data structure. The system can, for example, do analyses to identify arrows and/or components within the image, text within the image, relationships between items in the image, etc. This data can then be formatted to include text, such that both the images and the associated text can be added to the concept data structure with relationships to other data within the data structure. For example, a diagram of relationships can be processed and added to a concept data structure to add relationships to other concept data structures.

The relationships between the different pieces of data within the concept data structure can have associated weights to one another and the overall concept being analyzed, based on their relatedness. In this manner the system can being a data structure containing all of the information, both text and images, related to a given topic, with that information internally defined by relationships which can be weighted. Concepts with associations that are more closely related, or have higher relative counts, will garner higher weights than disparately related pieces of information. Information which is vague, extremely common, or overly used (stop words and articles) will typically be low rated or removed.

In some cases, this data structure can then be transmitted or shared between systems or users, such that the concept data structure of one system can be shared with other systems. In such instances, the shared data structures can act as additional data sets for the new systems, allowing distinct concept data structures to search the data of the transmitted/received data structure for additional, related data.

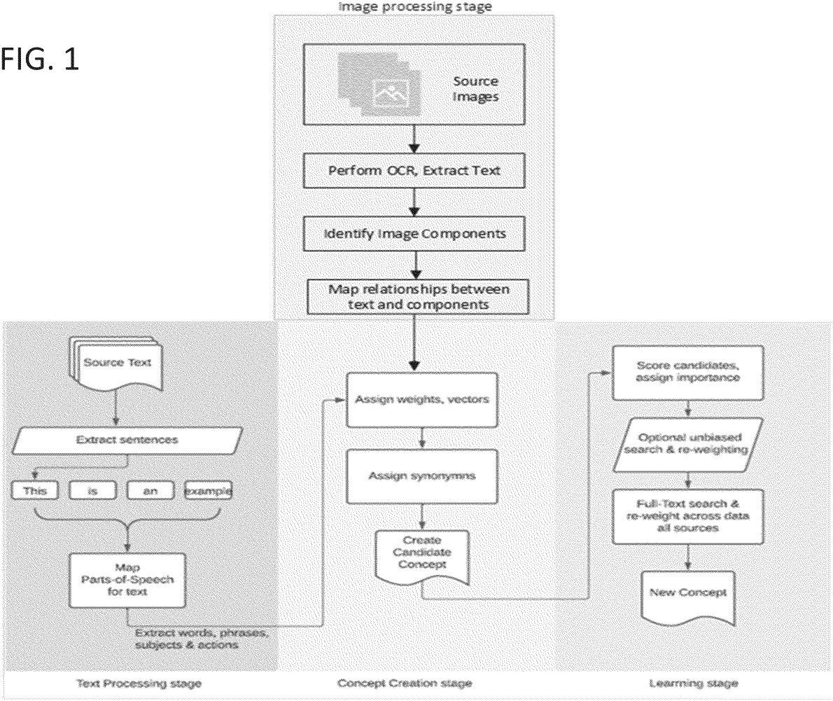

FIG. 1 illustrates an example process flow for combining text and image information into a concept data structure. As illustrated, the system can take source text and use natural language processing to extract sentences, phrases, nouns, verbs, etc. from within the text. The system can also process images using image processing and optical character recognition to identify text, figures, items/components within images, and map relationships between the text and/or components. The system can then use the parsed text and image data to build the concept data structure. In doing so, the system can assign weights/vectors to the data, include synonyms or other similar/related data, and create a candidate concept. The candidate concept can then be scored, with one or more aspects of the concept assigned a level of importance. In some configurations, the system can do unbiased searching and reweighting, can use machine learning to evaluate relationships between data, use machine learning to identify likely sources for new information, and/or do full-text searching and re-weighting of the collected data across all data sources. The result is a new concept data structure which can be used by analysts to review information associated with the overall concept, to share with other systems as needed, etc.

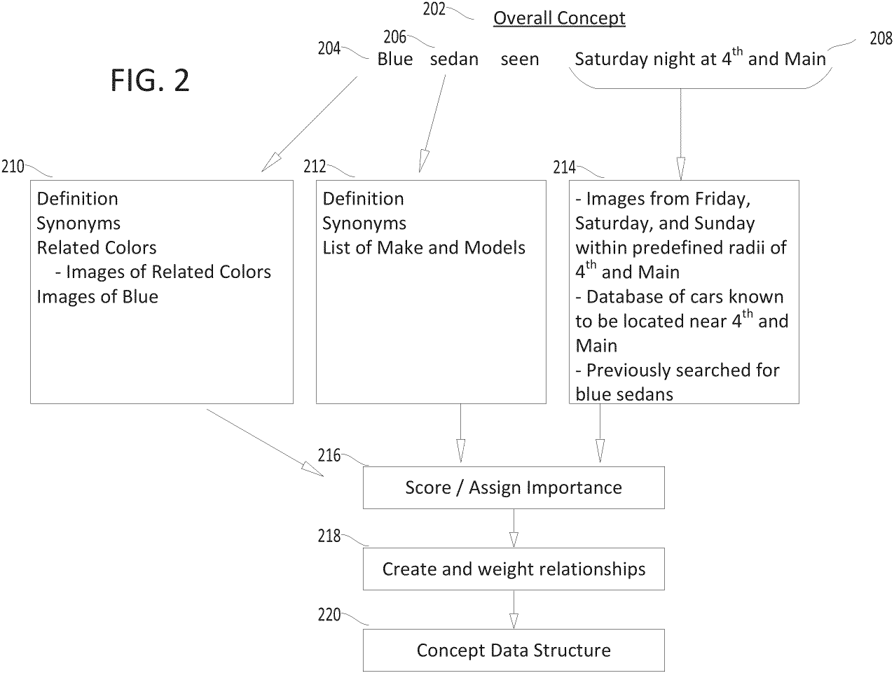

FIG. 2 illustrates an example of combining text and image information for a specific topic. In this case, the concept 202 is a “Blue sedan seen Saturday night at 4^{th} and Main,” which could be used by law enforcement in searching for a particular vehicle, or by a non-law enforcement user who saw the vehicle and is searching for others similar to it. As illustrated, the system can parse the concept into different adjectives, nouns, subjects, verbs, dates, locations, etc. “Blue” 204 can result in data 210 associated with the word blue 204, such as a definition, synonyms, related colors (e.g., turquoise, cyan), and images of blue, with the data being stored in a concept data structure. Likewise, “Sedan” 206 can result in data 212 associated with the word sedan 206, such as definitions, synonyms, a list of makes and models, etc. “Saturday night at 4^{th} and Main” 208 can result in data 214 from multiple resources, such as images from dates on Saturday as well as the Friday preceding the Saturday and the Sunday following the Saturday. In some configurations, those images may be from within a given radius of the “4^{th} and Main” location. In other configurations, images may be weighted based on how close to 4^{th} and Main they were when the image was captured. Additional exemplary data could include information from a data set identifying all cars (not just blue sedans) which were located near 4^{th} and Main, as well as previously searched-for blue sedans.

With different aspects of data compiled, the system can then score and assign importance 216 to the different pieces of collected data 210, 212, 214, and create and weight relationships 218 between that data 210, 212, 214. Using this information, the system can construct a concept data structure 220 which contains the relevant data and where the data is weighted according to relevance.

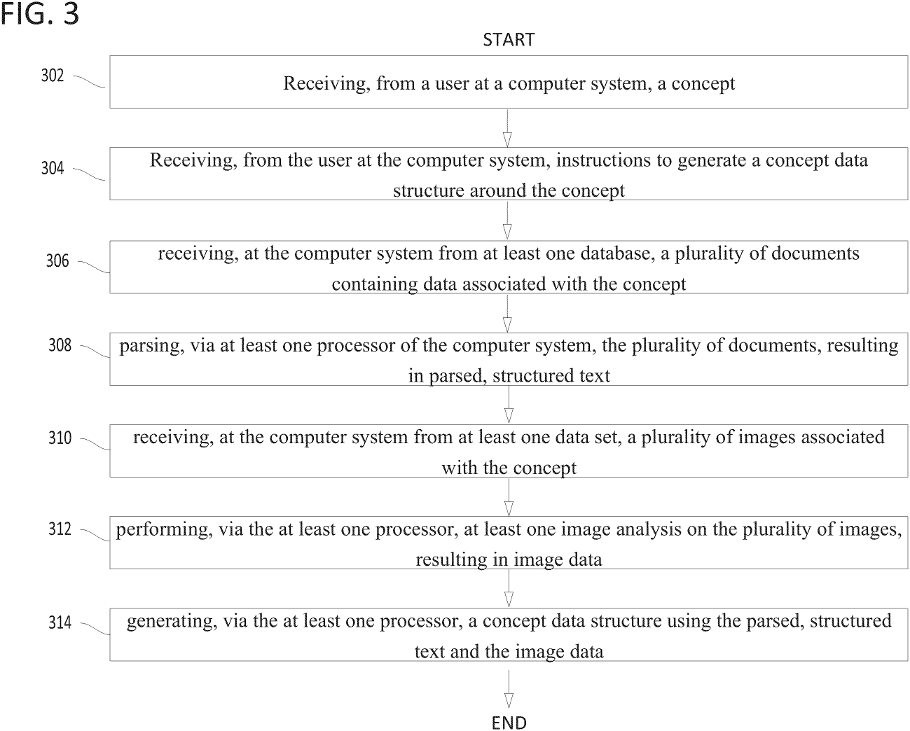

FIG. 3 illustrates an example method embodiment. As illustrated, a system configured as disclosed herein can receive, from a user at a computer system, a concept (302), and receive, from the user at the computer system, instructions to generate a concept data structure around the concept (304). The computer system can also receive, from at least one data set, a plurality of documents containing data associated with the concept (306), and parse, via at least one processor of the computer system, the plurality of documents, resulting in parsed, structured text (308). The computer system can further receive, from at least one data set, a plurality of images associated with the concept (310) and perform, via the at least one processor, at least one image analysis on the plurality of images, resulting in image data (312). The system can then generate, via the at least one processor, a concept data structure using the parsed, structured text and the image data (314).

In some configurations, the concept data structure data and relationships between the data are weighted.

In some configurations, the at least one image analysis can include optical character recognition, arrow recognition, and component recognition.

In some configurations, the parsing of the plurality of documents can include use of at least one natural language processing algorithm.

In some configurations, the exemplary method can further include transmitting the concept data structure to a distinct computer system.

In some configurations, the exemplary method can further include executing, via the at least one processor, a machine learning algorithm on the concept data structure. In such configurations the machine learning algorithm can reweight the data and the relationships of the concept data structure.

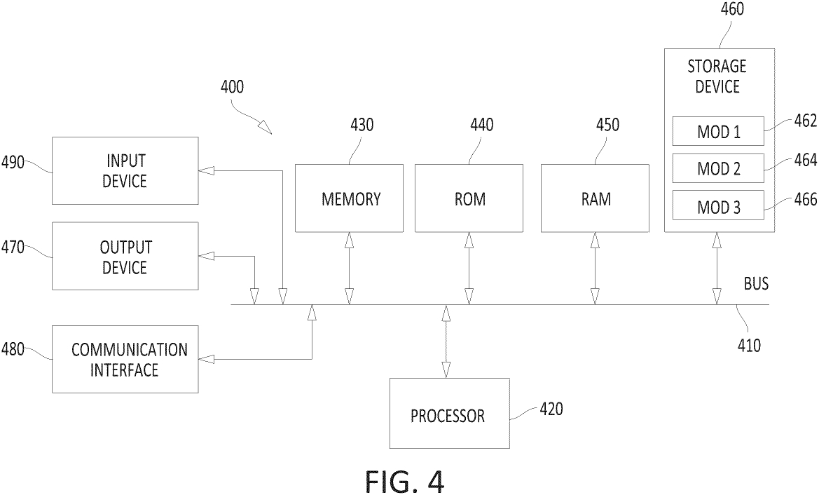

With reference to FIG. 4, an exemplary system includes a general-purpose computing device 400, including a processing unit (CPU or processor) 420 and a system bus 410 that couples various system components including the system memory 430 such as read-only memory (ROM) 440 and random access memory (RAM) 450 to the processor 420. The system 400 can include a cache of high-speed memory connected directly with, in close proximity to, or integrated as part of the processor 420. The system 400 copies data from the memory 430 and/or the storage device 460 to the cache for quick access by the processor 420. In this way, the cache provides a performance boost that avoids processor 420 delays while waiting for data. These and other modules can control or be configured to control the processor 420 to perform various actions. Other system memory 430 may be available for use as well. The memory 430 can include multiple different types of memory with different performance characteristics. It can be appreciated that the disclosure may operate on a computing device 400 with more than one processor 420 or on a group or cluster of computing devices networked together to provide greater processing capability. The processor 420 can include any general purpose processor and a hardware module or software module, such as module 1 462, module 2 464, and module 3 466 stored in storage device 460, configured to control the processor 420 as well as a special-purpose processor where software instructions are incorporated into the actual processor design. The processor 420 may essentially be a completely self-contained computing system, containing multiple cores or processors, a bus, memory controller, cache, etc. A multi-core processor may be symmetric or asymmetric.

The system bus 410 may be any of several types of bus structures including a memory bus or memory controller, a peripheral bus, and a local bus using any of a variety of bus architectures. A basic input/output (BIOS) stored in ROM 440 or the like, may provide the basic routine that helps to transfer information between elements within the computing device 400, such as during start-up. The computing device 400 further includes storage devices 460 such as a hard disk drive, a magnetic disk drive, an optical disk drive, tape drive or the like. The storage device 460 can include software modules 462, 464, 466 for controlling the processor 420. Other hardware or software modules are contemplated. The storage device 460 is connected to the system bus 410 by a drive interface. The drives and the associated computer-readable storage media provide nonvolatile storage of computer-readable instructions, data structures, program modules and other data for the computing device 400. In one aspect, a hardware module that performs a particular function includes the software component stored in a tangible computer-readable storage medium in connection with the necessary hardware components, such as the processor 420, bus 410, display 470, and so forth, to carry out the function. In another aspect, the system can use a processor and computer-readable storage medium to store instructions which, when executed by a processor (e.g., one or more processors), cause the processor to perform a method or other specific actions. The basic components and appropriate variations are contemplated depending on the type of device, such as whether the device 400 is a small, handheld computing device, a desktop computer, or a computer server.

Although the exemplary embodiment described herein employs the hard disk 460, other types of computer-readable media which can store data that are accessible by a computer, such as magnetic cassettes, flash memory cards, digital versatile disks, cartridges, random access memories (RAMs) 450, and read-only memory (ROM) 440, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 400, an input device 490 represents any number of input mechanisms, such as a microphone for speech, a touch-sensitive screen for gesture or graphical input, keyboard, mouse, motion input, speech and so forth. An output device 470 can also be one or more of a number of output mechanisms known to those of skill in the art. In some instances, multimodal systems enable a user to provide multiple types of input to communicate with the computing device 400. The communications interface 480 generally governs and manages the user input and system output. There is no restriction on operating on any particular hardware arrangement and therefore the basic features here may easily be substituted for improved hardware or firmware arrangements as they are developed.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

We claim:

1. A method comprising:
receiving, from a user at a computer system, a concept;
receiving, from the user at the computer system, instructions to generate a concept data structure around the concept;
receiving, at the computer system from at least one data set, a plurality of documents containing data associated with the concept;
parsing, via at least one processor of the computer system, the plurality of documents, resulting in parsed, structured text;
receiving, at the computer system from at least one data set, a plurality of images associated with the concept;
performing, via the at least one processor, at least one image analysis on the plurality of images, resulting in image data; and
generating, via the at least one processor, a concept data structure using the parsed, structured text and the image data.

2. The method of claim 1, wherein within the concept data structure data and relationships between the data are weighted.

3. The method of claim 1, wherein the at least one image analysis comprises optical character recognition, arrow recognition, and component recognition.

4. The method of claim 1, wherein the parsing of the plurality of documents comprises use of at least one natural language processing algorithm.

5. The method of claim 1, further comprising transmitting the concept data structure to a distinct computer system.

6. The method of claim 1, further comprising:
executing, via the at least one processor, a machine learning algorithm on the concept data structure.

7. The method of claim 6, wherein the machine learning algorithm reweights the data and the relationships of the concept data structure.

8. A system comprising:
at least one processor; and
a non-transitory computer-readable storage medium having instructions stored which, when executed by the at least one processor, cause the at least one processor to perform instructions comprising:
receiving, from a user, a concept;
receiving, from the user, instructions to generate a concept data structure around the concept;
receiving, from at least one data set, a plurality of documents containing data associated with the concept;
parsing the plurality of documents, resulting in parsed, structured text;
receiving, from at least one data set, a plurality of images associated with the concept;
performing at least one image analysis on the plurality of images, resulting in image data; and
generating a concept data structure using the parsed, structured text and the image data.

9. The system of claim 8, wherein within the concept data structure data and relationships between the data are weighted.

10. The system of claim 8, wherein the at least one image analysis comprises optical character recognition, arrow recognition, and component recognition.

11. The system of claim 8, wherein the parsing of the plurality of documents comprises use of at least one natural language processing algorithm.

12. The system of claim 8, the non-transitory computer-readable storage medium having additional instructions stored which, when executed by the at least one processor, cause the at least one processor to perform operations comprising transmitting the concept data structure to a distinct computer system.

13. The system of claim 8, the non-transitory computer-readable storage medium having additional instructions stored which, when executed by the at least one processor, cause the at least one processor to perform operations comprising executing, via the at least one processor, a machine learning algorithm on the concept data structure.

14. The system of claim 13, wherein the machine learning algorithm reweights the data and the relationships of the concept data structure.

15. A non-transitory computer-readable storage medium having instructions stored which, when executed by at least one processor, cause the at least one processor to perform instructions comprising:
receiving, from a user, a concept;
receiving, from the user, instructions to generate a concept data structure around the concept;
receiving, from at least one data set, a plurality of documents containing data associated with the concept;
parsing the plurality of documents, resulting in parsed, structured text;
receiving, from at least one data set, a plurality of images associated with the concept;
performing at least one image analysis on the plurality of images, resulting in image data; and
generating a concept data structure using the parsed, structured text and the image data.

16. The non-transitory computer-readable storage medium of claim 15, wherein within the concept data structure data and relationships between the data are weighted.

17. The non-transitory computer-readable storage medium of claim 15, wherein the at least one image analysis comprises optical character recognition, arrow recognition, and component recognition.

18. The non-transitory computer-readable storage medium of claim 15, wherein the parsing of the plurality of documents comprises use of at least one natural language processing algorithm.

19. The non-transitory computer-readable storage medium of claim 15, having additional instructions stored which, when executed by the at least one processor, cause the at least one processor to perform operations comprising transmitting the concept data structure to a distinct computer system.

20. The non-transitory computer-readable storage medium of claim 15, having additional instructions stored which, when executed by the at least one processor, cause the at least one processor to perform operations comprising executing, via the at least one processor, a machine learning algorithm on the concept data structure.
